(19) United States
(12) Patent Application Publication
(10) Pub. No.: US 2015/0363752 A1
(43) Pub. Date: Dec. 17, 2015

(54) PAYMENT NETWORK WITH SERVICE PROVIDER DIRECTORY FUNCTION

(71) Applicant: MasterCard International Incorporated, Purchase, NY (US)

(72) Inventors: Debbie Kimberg, Chesterfield, MO (US); Christina Wehmeier, Chesterfield, MO (US); Santhanam Srinivasan, North Brunswick, NJ (US)

(21) Appl. No.: 14/704,182

(22) Filed: May 5, 2015

Related U.S. Application Data
(60) Provisional application No. 62/012,288, filed on Jun. 14, 2014.
(60) Provisional application No. 62/012,099, filed on Jun. 13, 2014.

(51) Int. Cl. G06Q 20/10

(52) U.S. Cl. CPC G06Q 20/10

(57) ABSTRACT

A request for a funds transfer is received in a computer. The request includes addressing information for an individual recipient of the requested funds transfer. The computer retrieves identification information that identifies a service provider for the recipient. A request is routed from the computer to a service provider by using the service provider identification information. The request to the service provider is for requesting recipient account information. The computer receives a payment account number from the service provider. The payment account number identifies a payment account that belongs to the recipient. The computer executes the requested funds transfer by routing the funds transfer to the recipient's payment account using the received payment account number.

### CROSS REFERENCE TO RELATED APPLICATIONS

This application claims the benefit of U.S. Provisional Patent Application Nos. 62/012,099 filed on Jun. 13, 2014; and 62/012,288 filed on Jun. 14, 2014, the contents of which applications are hereby incorporated by reference for all purposes.

### BACKGROUND

It has previously been proposed to utilize a payment card account system to implement person-to-person payments. One such system is disclosed in U.S. Pat. No. 8,271,362, which is assigned to MasterCard International Incorporated, the assignee hereof.

One challenge that is faced in implementing such systems (sometimes referred to as “P2P” or “personal payments” systems) is obtaining the account information needed to route the payment transaction to the intended recipient. This same issue may be faced in connection with other types of payment transactions as well. One issue that increases the difficulty in solving this challenge is that potential funds transfer recipients may often be reluctant to disclose potentially sensitive information such as their bank account number or their payment account number.

### BRIEF DESCRIPTION OF THE DRAWINGS

Features and advantages of some embodiments of the present disclosure, and the manner in which the same are accomplished, will become more readily apparent upon consideration of the following detailed description of the disclosure taken in conjunction with the accompanying drawings, which illustrate preferred and exemplary embodiments and which are not necessarily drawn to scale, wherein:

FIG. 1 is a block diagram representation of a personal payments system provided in accordance with aspects of the present invention.

FIG. 2 is a block diagram that presents another view of the system of FIG. 1, particularly within the context of a single payment transaction.

FIG. 3 is a block diagram of a computer system that provides part of the functionality of the system of FIGS. 1 and 2 in accordance with aspects of the present invention.

FIG. 3A is a block diagram of a computer system that provides part of the functionality of the system of FIGS. 1 and 2 in accordance with aspects of the present invention.

FIG. 3B is a simplified tabular illustration of a directory database that may be maintained in the computer system of FIG. 3A in accordance with aspects of the present invention.

FIG. 4 is a flow chart that illustrates a process that may be performed in the system of FIGS. 1 and 2 in accordance with aspects of the present invention.

FIG. 4A is a flow chart that illustrates a process that may be performed in the system of FIGS. 1 and 2 in accordance with aspects of the present invention.

FIGS. 5 and 6 are example screen displays that may be provided to a payment transaction recipient in the system of FIGS. 1 and 2 in accordance with aspects of the present invention.

### DETAILED DESCRIPTION

In general, and for the purpose of introducing concepts of embodiments of the present invention, a directory function may be established in a central manner in a payments system. For example, the directory function may be associated with a payment network. Potential funds transfer recipients may be identified in the directory by contact information including one or more of e-mail address, mobile phone number and/or name plus residence address. The directory entry for the potential recipient may also indicate the standard system institution identifier for the financial institution or other service provider through which the potential recipient participates in the system. When a funds transfer transaction is initiated in which the recipient is identified by an identifier (such as an email address, phone number, or other identifier) and/or other contact information, the directory function looks up the recipient's entry and retrieves the service provider identifier. The payment network then requests the recipient's account number from the indicated service provider (which may be performed substantially in real-time or during the course of a single session or interaction). The payment network receives the recipient's account number from the service provider and routes the requested payment transaction using the recipient's account number using an appropriate network (such as a payment card network, a clearinghouse network, a mobile network or the like).

The term “personal payments” is used generally herein to refer to payments to persons or other entities from a business, government, non-profit or other person or entity. As an example, a consumer could give their email address to a business (such as, for example, AT&T) when the consumer purchases an AT&T mobile phone. For example, AT&T may offer a $20 rebate. Instead of providing the $20 rebate in the form of a gift card, AT&T may use the system of the present invention to provide the rebate as a credit to an account of the consumer (such as the consumer's debit card account). Using the system of the present invention, AT&T could request payment of the $20 rebate to the consumer's email address to cause the $20 to be credited to an account of the consumer.

The term “payment transaction” generally refers to transactions across a network such as a transaction involving a payment card network, a clearing house network (such as an “ACH” transaction or the like), a mobile money network or the like.

Teachings from the present disclosure may provide a method for independent P2P systems to interoperate so that a funds-transfer sender can use service provider A (e.g., an FI or digital P2P service provider) and the payment can be received by the recipient who has registered with service provider B to make P2P payments. The interoperability of the service providers allows for payments to be made to the recipient without disclosing the recipient's private account information.

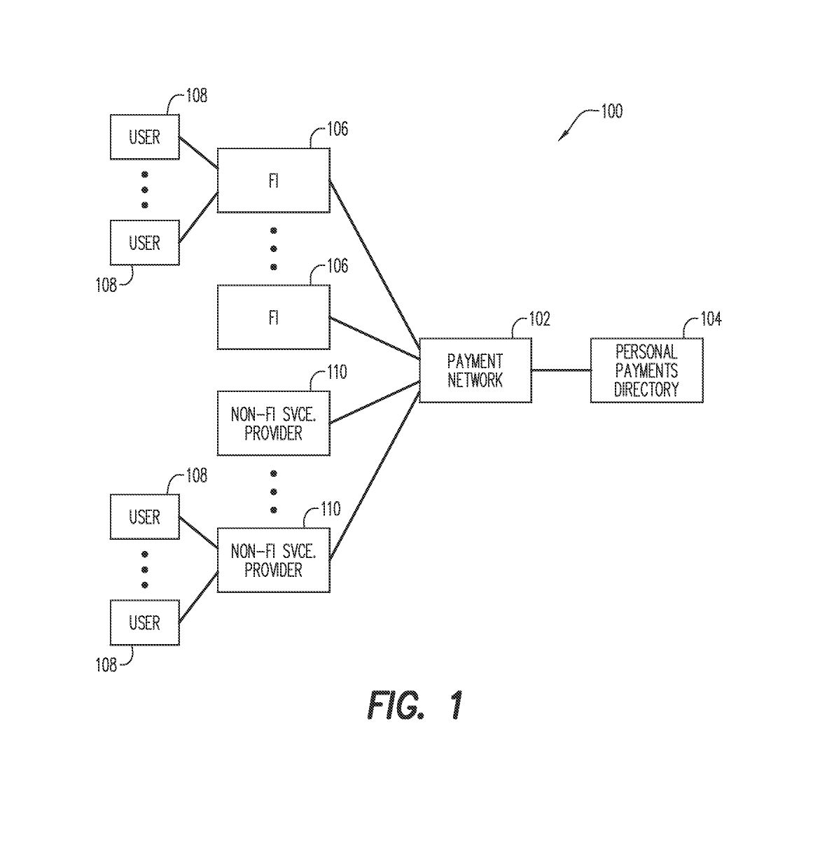

FIG. 1 is a block diagram representation of a personal payments system 100 provided in accordance with aspects of the present invention.

A central role in the system 100 is played by a payment network 102. The payment network 102 may be similar in many respects to a conventional payment network such as the well-known Banknet payment network that is operated by MasterCard International Incorporated, which is the assignee hereof. In addition to its conventional features, the payment network 102 may have a personal payments directory function (block 104) associated therewith.

The system 100 may also include numerous financial institutions (FIs) 106 as participants therein. The FIs 106 may issue payment card accounts to system users 108, and may be in communication with the payment network 102 for the purposes of requesting and receiving funds transfer transactions, and also for the purpose of enrolling users 108 in the personal payments directory 104. (To simplify the drawing, users 108 are explicitly shown as associated with only one of the FIs 106; nevertheless it should be understood that all of the FIs 106 have customers who are users of the system 100.) In connection with the system 100, the FIs act as personal payment service providers to their customer/users 108.

The system 100 may also include other service providers 110, which are not FIs. For example, mobile network operators (MNOs) and/or payment service providers (PSPs) may also act as personal payment service providers to additional customer/users 108. (Again to simplify the drawing, users 108 are explicitly shown as associated with only one of the non-FI service providers 110, but it should be understood that all of the non-FI service providers 110 have customers who are users of the system 100.) The non-FI service providers 110 are also in communication with the payment network 102 with respect to personal payment transactions and for the purpose of enrolling users 108 in the personal payments directory 104. Some users 108 may receive services from more than one of the FIs 106/service providers 110.

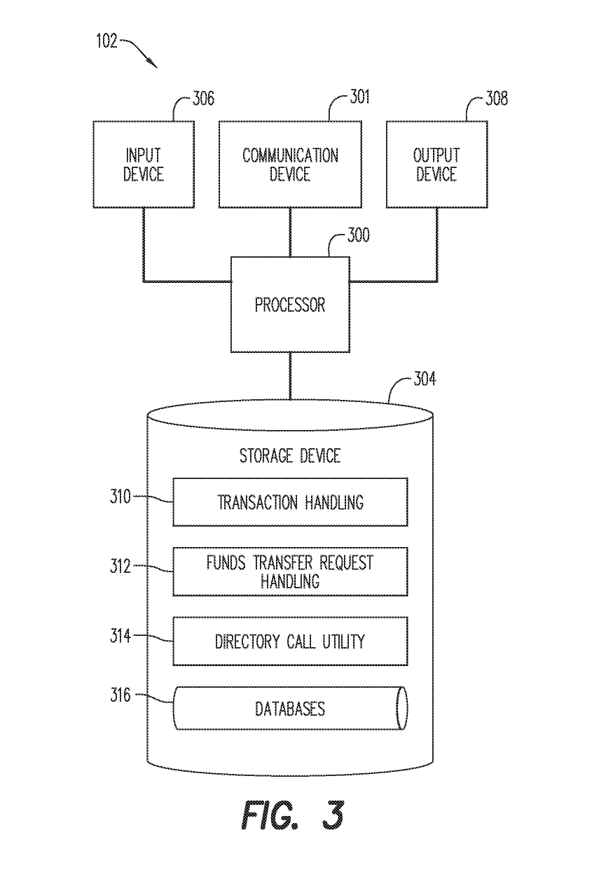

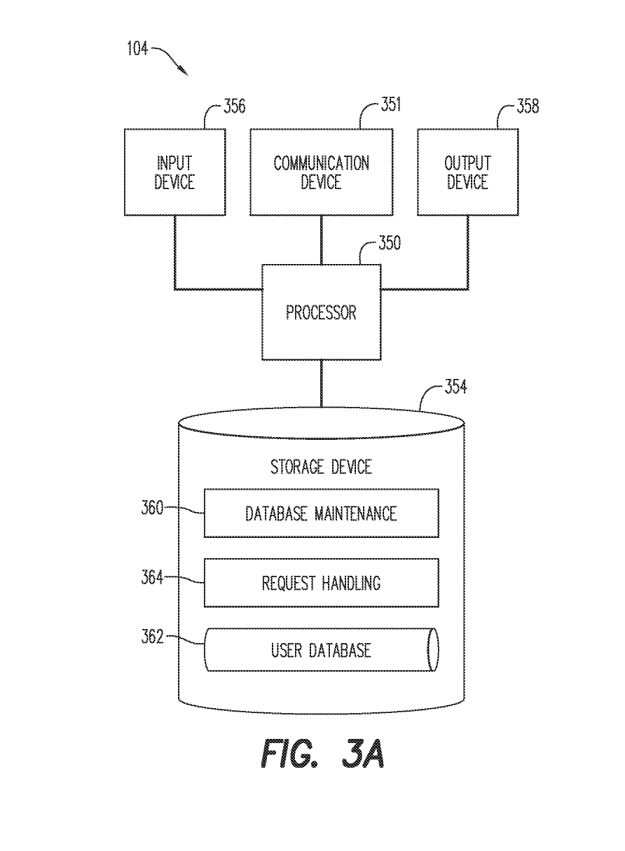

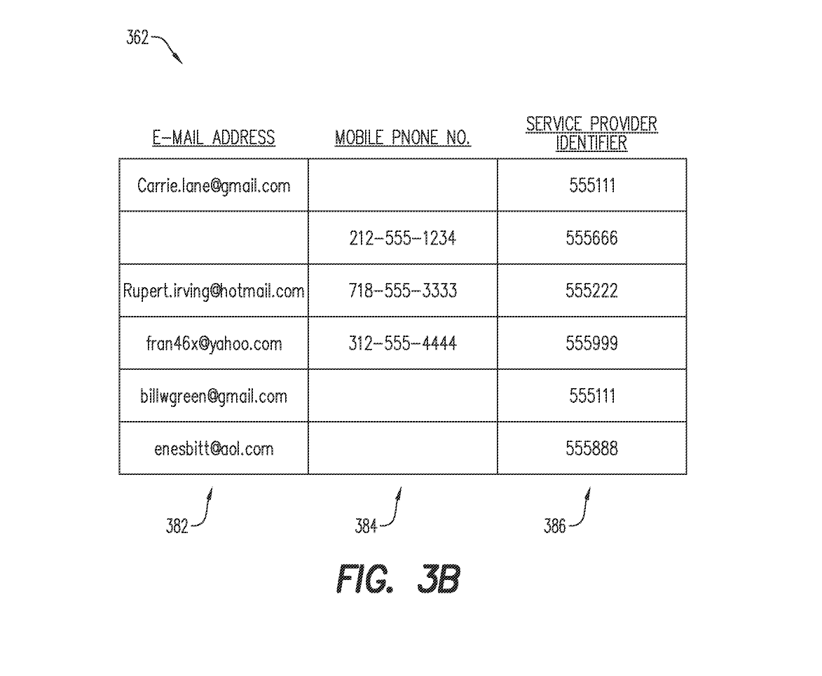

When a service provider 106 or 110 enrolls a user 108 in the personal payments directory 104, the resulting entry may, in some embodiments and/or in some situations take a minimal form. In the minimal form, the entry may include just (a) an alias for the user, such as the user's mobile phone number; and (b) an identifier for the user's service provider such as an ICA (Interbank Card Association) number or a unique account number and payment service provider identifier. In other cases or in other embodiments, the entry for the user may also include, e.g., the user's name and/or additional contact information for the user; and may also include the user's payment card account number or other account identifying information. (An example embodiment of a directory database will be discussed below in connection with FIG. 3B.)

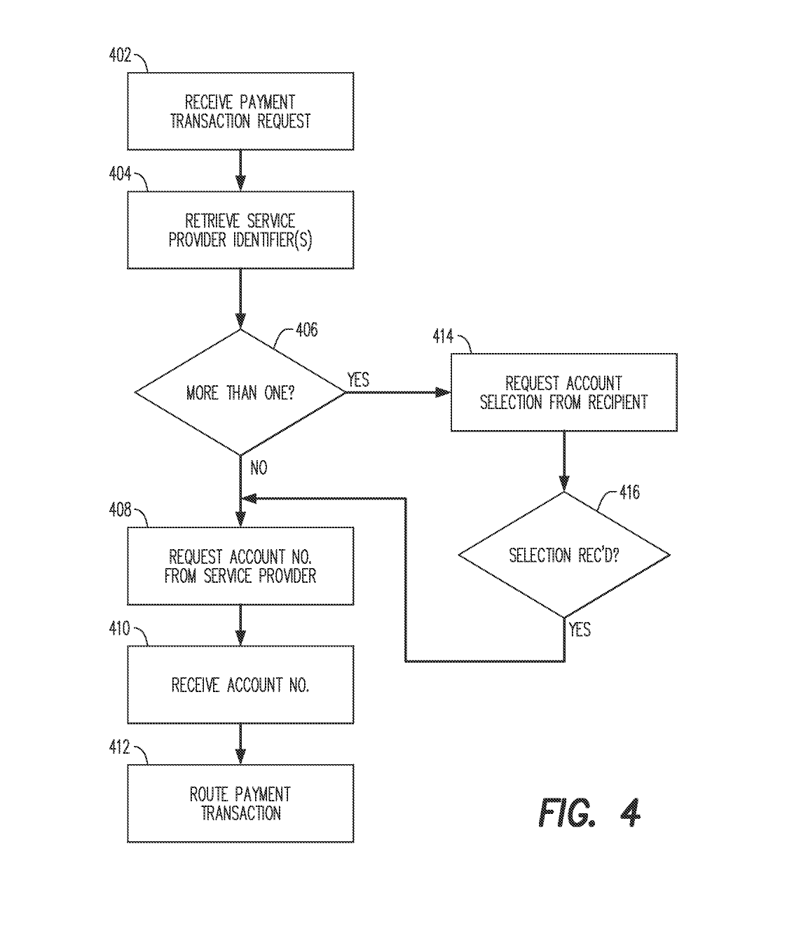

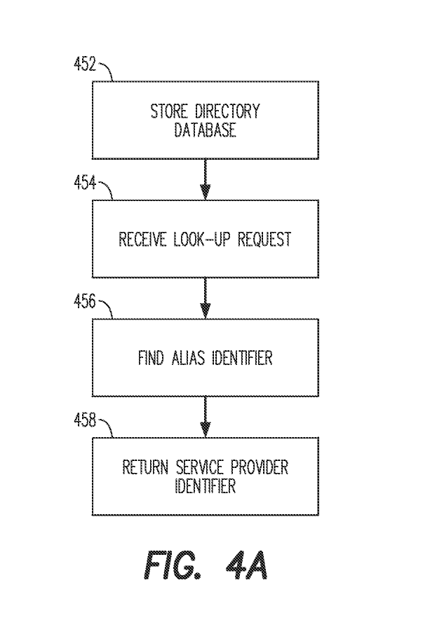

It should be understood that each block shown in FIG. 1 represents not only an entity/system participant, but also represents a respective computing device operated by the respective entity/system participant. For example, each user 108 may interact with the system 100 by using a device such as a conventional smartphone, tablet computer, personal computer or laptop computer. Each service provider 106 or 110 may operate one or more computers, which may be conventional in their hardware aspects, and which may be programmed to participate in the system 100 as described herein. Further, the payment network 102 may be constituted at least in part by one or more computers; consequently, block 102 should also be deemed to represent a payment network computer system. Details of the payment network computer system 102 will be described below, in connection with FIGS. 3 and 4.

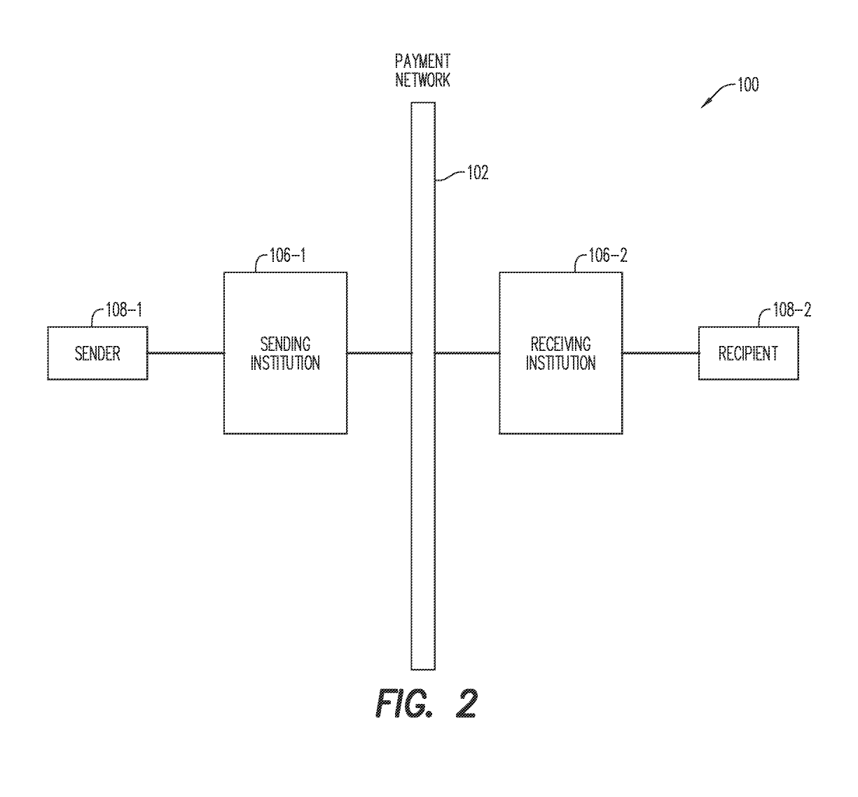

FIG. 2 is a block diagram that presents another view of the system 100, particularly within the context of a single payment transaction. Reference will now be made to FIG. 2.

A sender 108-1 for a particular payment transaction may interact with his/her service provider (the “sending institution” or “payment originator”) 106-1 to request that the transaction take place. The sending institution 106-1 may route the transaction via the payment network 102 to the service provider (the “receiving institution”) 106-2 for the transaction recipient 108-2. The receiving institution 106-2 may inform the recipient 108-2 that the payment transaction has taken place.

(It is in a sense assumed in the above description of FIG. 2 that the sending and receiving institutions are FIs. However, this need not necessarily be the case. For example, either or both of the sending institution and the receiving institution may be non-FI service providers. In such situations it will often be the case that an FI is associated in the background with the non-FI service provider to facilitate connectivity to the payment network 102.)

In some embodiments, the sender may make the initial request for a payment transaction to a non-FI service provider (not shown in FIG. 2), which will then forward the request to the sending institution.

Aspects of the present disclosure are particularly relevant to situations in which the sender 108-1 does not/cannot identify the recipient 108-2 by the recipient's payment card account number or by other routing information (such as, for example, a mobile phone number, an email address, or the like).

While not shown in FIG. 2, other entities or devices may also participate in the system. For example, a service provider offering payment services may be involved in some transactions or systems. The service provider may facilitate transactions between a sender 108-1 and a sending institution 106-1. Other service providers may also be involved in some embodiments.

FIG. 3 is a block diagram that illustrates an embodiment of the payment network computer system 102 represented in FIGS. 1 and 2. It should be understood that the computer system may also encompass, or have associated with it, computing resources that implement the directory function 104 (FIG. 1). Alternatively, the directory function may be implemented on a separate computer from the payment network computer system 102; an illustration of this situation occurs in FIG. 3A, which will be discussed below.

Referring, then, to FIG. 3, the payment network computer system 102 may be conventional in its hardware aspects but may be controlled by software to cause it to function as described herein. For example, the payment network computer system 102 may be constituted by conventional server computer and/or mainframe computer hardware.

The payment network computer system 102 may include a computer processor 300 operatively coupled to a communication device 301, a storage device 304, an input device 306 and an output device 308.

The computer processor 300 may be constituted by one or more conventional processors. Processor 300 operates to execute processor-executable steps, contained in program instructions described below, so as to control the payment network computer system 102 to provide desired functionality.

Communication device 301 may be used to facilitate communication with, for example, other devices (such as computers operated by service providers 106, 110). For example communication device 301 may comprise numerous communication ports (not separately shown), to allow the payment network computer system 102 to communicate simultaneously with a number of other devices and computers, including communications as required to receive and execute numerous requests for payment transactions.

Input device 306 may comprise one or more of any type of peripheral device typically used to input data into a computer. For example, the input device 306 may include a keyboard and a mouse. Output device 308 may comprise, for example, a display and/or a printer.

Storage device 304 may comprise any appropriate information storage device, including combinations of magnetic storage devices (e.g., magnetic tape and hard disk drives), optical storage devices such as CDs and/or DVDs, and/or semiconductor memory devices such as Random Access Memory (RAM) devices and Read Only Memory (ROM) devices, as well as so-called flash memory. Any one or more of such information storage devices may be considered to be a computer-readable storage medium or a computer usable medium or a memory.

Storage device 304 stores one or more programs for controlling processor 300. The programs comprise program instructions (which may be referred to as computer readable program code means) that contain processor-executable process steps of the payment network computer system 102, executed by the processor 300 to cause the payment network computer system 102 to function as described herein.

The programs may include one or more conventional operating systems (not shown) that control the processor 300 so as to manage and coordinate activities and sharing of resources in the payment network computer system 102, and to serve as a host for application programs that run on the payment network computer system 102.

The programs stored in the storage device 304 may also include a transaction handling application program 310 that enables the payment network computer system 102 to provide functionality supported by conventional payment networks for payment card systems, including handling of payment transactions that transfer funds from a sender's payment card account to a recipient's payment card account. Moreover, the storage device 304 may also store an application program 312 that enables the payment network computer system 102 to handle requests for funds transfers in accordance with aspects of the present invention. In addition, the storage device 304 may store a program module or utility 314 that augments conventional payment transaction handling by enabling the payment network computer system 102 to interact with user/service provider directory functionality as described herein. For example, the programs stored in the storage device 304 may control the processor 300 to provide functionality as described below in connection with FIG. 4.

Other programs stored in the storage device 304 may include a reporting application, which may respond to requests from system administrators for reports on the activities performed by the payment network computer system 102, communication software, device drivers, etc.

The storage device 304 may also store one or more databases 316 required for operation of the payment network computer system 102. Such databases 312 may include, for example, a database for storing data related to payment card account system transactions handled by the payment network computer system 102. Additional databases as required for operation of the payment network computer system 102 may also be included among the databases 316 indicated in FIG. 3.

FIG. 3A is a block diagram representation of a computer system that embodies the directory functionality represented by block 104. Accordingly, the computer system illustrated in FIG. 3A will sometimes be referred to as the “directory computer 104”. It should be understood that the hardware and software resources described with reference to FIG. 3A may, in some embodiments, be at least partially integrated with the payment network computer system 102 illustrated in FIG. 3.

The directory computer 104, to the extent that it is separate from the payment network computer system 102, may have the same sort of hardware architecture as was described above in connection with the description of the payment network computer system 102 in conjunction with FIG. 3. Thus, the directory computer 104 may include, for example, a processor 350, a communication device 351, a storage device 354, an input device 356 and an output device 358. At least some of the components of directory computer 104 may be in communication with each other. The components enumerated in this paragraph may resemble, in their hardware and functional aspects, the components of the payment network computer system 102, as described above in connection with FIG. 3. However, the directory computer 104 (to the extent it is separate from the payment network computer system 102) may be programmed in a different manner from the payment network computer system 102 so that the former computer system provides different functionality from the latter computer system.

The programs stored in the storage device 354 of the directory computer 104 may include one or more application programs (block 360) to program the directory computer 104 to build, maintain and update a directory database 362 that serves as a resource for service provider look-up functionality as described herein. Moreover, the programs stored in the storage device 354 may also include a program module 364 which programs the directory computer 104 to handle and respond to requests for directory look-ups. The storage device 354 may further store other programs and databases (not explicitly shown) as required for operation of the directory computer 104. Functionality provided by the directory computer 104 will be further described below in connection with FIG. 4A.

FIG. 3B is a simplified tabular illustration of an embodiment of the directory database 362 shown in FIG. 3A. Each row shown in FIG. 3B represents a respective entry for a user of the system shown in FIGS. 1 and 2. The data fields in column 382 represent user email addresses that may serve as alias identifiers for users/funds transfer recipients. The data fields in column 384 represent user mobile telephone numbers that may serve as alias identifiers for users/funds transfer recipients. It will be noted that in the case of some user entries, the respective entry may include both types of alias identifiers; i.e., both an email address and a mobile telephone number. In some embodiments, other types of user identifiers may also or alternatively be employed. Just one example of another type of user identifier may be an assumed name or “handle” or “alias” that a gaming system participant may use in connection with his/her gaming activities.

In column 386, each data field contains the standard system identifier code for the service provider for the user that corresponds to the respective data entry/row. Thus the database 362 may be used to look up the user's service provider (more precisely, to look up the identifier for the user's service provider) based on one or more alias identifiers for the user. In the particular example illustrated in FIG. 3B, the service provider identifiers are shown as consisting of six digits, but identifiers of other lengths (e.g., four digits) and/or including at least some non-numeric characters, may alternatively be used.

FIG. 4 is a flow chart that illustrates a process that may be performed in the system 100 in accordance with aspects of the present invention. In particular, the functions illustrated in FIG. 4 may be performed by the payment network computer system 102. For the example process illustrated in FIG. 4, it is assumed that a payment transaction request is received by the payment network computer system 102, that the recipient is identified by an alias (such as the recipient's mobile phone number or e-mail address) and not by the recipient's payment card account number, that the recipient is listed under the alias in an entry in the directory function 104, and that the listing for the recipient does not include the recipient's payment card account number or other account information by which the transaction can be routed for the recipient's benefit.

At block 402 in FIG. 4, the payment network computer system 102 receives a payment transaction request as described immediately above. The recipient's alias, as referred to above, may be considered addressing information for the requested payment transaction. A problem to be solved by the process of FIG. 4 is that the payment transaction request does not provide information required to immediately route the payment transaction via the payment network.

At block 404, the payment network computer system 102 accesses the directory function 104 to retrieve the user's entry, based on the alias contained in the request, and more specifically, to retrieve the identifier (or identifiers) for the recipient's service provider or providers. (There may be more than one service provider for the recipient, because the recipient may have more than one payment card account—or other account—registered in the system 100, possibly provided by more than one service provider.)

Decision block 406 may follow block 404. At decision block 406, the payment network computer system 102 determines whether more than one service provider is listed in the directory entry for the transaction recipient. If not (i.e., if there is only one service provider listed for the recipient), then the process of FIG. 4 may advance from decision block 406 to block 408. At block 408, the payment network computer system 102 uses the service provider identifier (e.g., an ICA number or the like) to identify the recipient's service provider, and the payment network computer system 102 then proceeds to request the recipient's payment account number from the recipient's service provider.

Block 410 may follow block 408. At block 410, the payment network computer system 102 may receive the recipient's payment account number from the recipient's service provider. At this point, the payment network computer system 102 has all the information it needs to route the payment transaction in a conventional manner for the benefit of the indicated recipient. Accordingly block 412 follows block 410. Block 412 represents routing of the payment transaction by the payment network computer system 102 using the recipient's payment account number that was received at 410; block 412 further represents completion of the requested payment transaction. Processing at 410 may include receiving any of a variety of different payment account numbers such as, for example, a payment card account number, a bank account number, a mobile money account number or the like. The routing at 412 may include routing to a number of different networks, such as, for example, a payment card network, a clearing house network (such as the ACH), a mobile money network, or the like.

Referring again to decision block 406, if the payment network computer system 102 makes a positive determination at that decision block (i.e., if the payment network computer system 102 determines that more than one service provider is listed in the recipient's entry in the user directory), then the process of FIG. 4 may advance from decision block 406 to block 414.

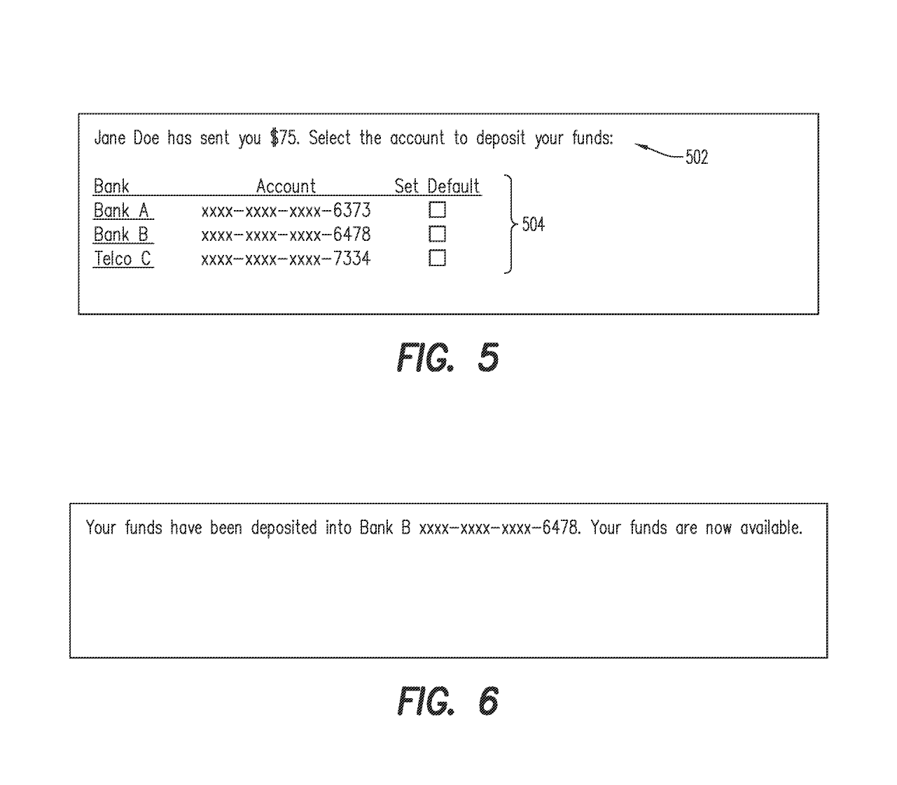

At block 414, the payment network computer system 102 may send a message to the recipient (e.g., via e-mail or mobile text messaging) to request that the recipient select which account the payment transaction should be routed to. For example, the message from the payment network computer system 102 to the recipient may result in a screen display such as FIG. 5 being displayed on the recipient's device.

Referring to FIG. 5, at 502 the recipient is informed that the payment transaction has been requested and the recipient, in turn, is requested to select the account that the recipient wishes to have the funds routed to.

At 504 in FIG. 5, the recipient's accounts registered in the system are listed to allow the recipient to select one of those accounts. Upon the recipient selecting one of the accounts, the recipient's device may send a message back to the payment network computer system 102 to indicate the selection.

Referring again to FIG. 4, decision block 416 follows block 414. At decision block 416, the payment network computer system 102 may determine whether it has received the indication from the recipient's device as to which account the recipient has selected to receive the funds. If the message indicating the account selection is received, then the payment network computer system 102 “knows” which of the recipient's service providers to contact to obtain the payment card account number (or other account number) for the account selected by the recipient. Accordingly, the payment network computer system 102 can proceed with the processes of blocks 408-412—as described above.

FIG. 6 shows another screen display that may be presented to the recipient via the recipient's device in connection with the process of FIG. 4. The purpose of this screen display is to confirm to the recipient that the payment transaction has been completed. Thus the screen display may be presented to the recipient at the conclusion of the process of block 412 in FIG. 4.

One advantage of the directory system and associated processes as described above is that the recipient's account number need not be exposed to the sender or the sender's service provider. The recipient's account number goes no further than the operator of the payment network 102, which is deemed to be a highly trustworthy entity. Further, the arrangements as described herein allow the sender to conveniently designate the recipient of a personal payment transaction by an alias such as the recipient's mobile phone number or email address, either of which may be very familiar to the sender.

In the case of a payment transaction request where the directory entry for the recipient already contains the recipient's payment card account number, the process of FIG. 4 can be short-circuited, in that the payment network computer system 102 may directly retrieve the account number from the directory and proceed with step 412, i.e., without having to contact the recipient's service provider to get the recipient's account number.

In some embodiments, the process of FIG. 4 may be expanded such that the recipient's entry in the directory database is updated to include the account number received at 410. In some embodiments, the communication received by the payment network computer system 102 at block 410 from the service provider may contain an indication as to whether or not the payment network computer system 102 is authorized to update the recipient directory entry with the account number.

In some embodiments, the process may also include providing a step or process for the recipient to select a default receiving account, so that future transactions can be automatically received at that default receiving account. The recipient may also be provided with a mechanism for modifying or deleting the default receiving account.

FIG. 4A is a flow chart that illustrates a process that may be performed in the system of FIGS. 1 and 2 in accordance with aspects of the present invention. In particular, FIG. 4A represents functionality that may be provided in the directory computer 104.

At 452 in FIG. 4A, the directory computer 104 may store a database such as that illustrated in simplified form in FIG. 3B. This may be considered a preliminary step in some senses, but also may be an ongoing process as the database may be frequently updated. In some embodiments, to insure security of the directory database 362 (FIG. 3B), creation and/or updating of the data entries may be performed only by request—via a secure communications channel—from a trusted entity such as an FI or service provider registered with the payment network.

At 454 in FIG. 4A, the directory computer 104 may receive a look-up request from the payment network computer system 102. This may correspond to the above-described block 404 of FIG. 4.

Continuing to refer to FIG. 4A, at block 456, the directory computer 104 may use the alias identifier contained in the request received at 454 to access the database 362 (FIGS. 3A, 3B). Upon successfully accessing the database using the alias identifier, the directory computer 104 may return the corresponding service provider identifier (block 458, FIG. 4A) to the payment network computer system 102. This may allow the payment network computer system 102 to complete block 404 in FIG. 4.

In some embodiments, the functionality ascribed in this discussion of FIG. 4A to the directory computer 104 may alternatively be performed by aspects of the payment network computer system 102 (FIG. 3).

The principles of this invention have applicability beyond payments based on payment card accounts. Any type of account may be employed, including a demand deposit bank account, a mobile money account, etc. It is also the case that the invention may be used with payment systems other than payment card account systems. For example, the invention may also be used in conjunction with ACH networks, mobile money networks, etc. Moreover, the payment system described herein may include more than one payment network. The system of the present invention is not limited to P2P transactions, but could also include, for example, B2P payments, rebate payments, government benefit disbursements, etc.

As used herein and in the appended claims, the term “computer” should be understood to encompass a single computer or two or more computers in communication with each other.

As used herein and in the appended claims, the term “processor” should be understood to encompass a single processor or two or more processors in communication with each other.

As used herein and in the appended claims, the term “memory” should be understood to encompass a single memory or storage device or two or more memories or storage devices.

As used herein and in the appended claims, a “server” includes a computer device or system that responds to numerous requests for service from other devices.

The flow charts and descriptions thereof herein should not be understood to prescribe a fixed order of performing the method steps described therein. Rather the method steps may be performed in any order that is practicable.

As used herein and in the appended claims, the term “payment card system account” includes a credit card account, a deposit account that the account holder may access using a debit card, a prepaid card account, or any other type of account from which payment transactions may be consummated. The terms “payment card system account” and “payment card account” and “payment account” are used interchangeably herein. The term “payment card account number” includes a number that identifies a payment card system account or a number carried by a payment card, or a number that is used to route a transaction in a payment system that handles debit card and/or credit card transactions. The term “payment card” includes a credit card, debit card, prepaid card, or other type of payment instrument, whether an actual physical card or virtual.

As used herein and in the appended claims, the term “payment card system” or “payment system” refers to a system for handling purchase transactions and related transactions. An example of such a system is the one operated by MasterCard International Incorporated, the assignee of the present disclosure. In some embodiments, the term “payment card system” may be limited to systems in which member financial institutions issue payment card accounts to individuals, businesses and/or other organizations.

Although the present disclosure has been described in connection with specific exemplary embodiments, it should be understood that various changes, substitutions, and alterations apparent to those skilled in the art can be made to the disclosed embodiments without departing from the spirit and scope of the disclosure as set forth in the appended claims.

What is claimed is:

1. A method comprising:
receiving, in a computer, a request for a funds transfer, the request including addressing information for an individual recipient of the funds transfer;
retrieving, by the computer, identification information that identifies a service provider for the recipient;
routing, from the computer, a request to the service provider by using the service provider identification information, the request from the computer for requesting recipient account information;
receiving, in the computer, from the service provider, a payment account number that identifies a payment account that belongs to the recipient; and
executing the requested funds transfer by routing the funds transfer to the recipient's payment account using the received payment account number.

2. The method of claim 1, wherein the addressing information includes an e-mail address for the recipient.

3. The method of claim 2, wherein the addressing information consists of an e-mail address for the recipient.

4. The method of claim 1, wherein the addressing information includes a mobile telephone number for the recipient.

5. The method of claim 4, wherein the addressing information consists of a mobile telephone number for the recipient.

6. The method of claim 1, wherein the service provider identification information includes an identification number that identifies the service provider.

7. The method of claim 1, wherein the request for a funds transfer originates from an individual.

8. The method of claim 1, wherein the request for a funds transfer originates from a business.

9. A method comprising:
receiving a request for a funds transfer, the request including an alias identifier for a recipient of the funds transfer, the request not including a destination account number for the funds transfer;
based on the alias identifier, looking up a service provider for the recipient;
obtaining the destination account number from the looked-up service provider;
inserting the obtained destination account number in the request; and
routing the request based on the inserted destination account number.

10. The method of claim 9, wherein the service provider is a payment service provider.

11. The method of claim 9, wherein the service provider is a mobile network operator.

12. The method of claim 9, wherein the looking-up step includes accessing a directory, said directory storing a plurality of entries, each of said entries corresponding to an alias identifier for a respective payment system user, said each entry indicating a service provider that corresponds to the respective payment system user.

13. The method of claim 12, wherein said each entry indicates the service provider by a standard identifier number that references the service provider.

14. The method of claim 13, wherein the service provider is one of: (a) a financial institution; (b) a payment service provider; or (c) a mobile network operator.

15. The method of claim 9, wherein the looking-up step indicates a plurality of service providers associated with the recipient;
the method further comprising:
sending a query to the recipient, said query requesting the recipient to select among the plurality of service providers; and
receiving a response to the query;
and wherein said routing step follows said step of receiving a response to the query.

16. A. method comprising:
storing a directory database, said directory database storing a plurality of entries, each of said entries corresponding to an alias identifier for a respective payment system user, said each entry indicating a service provider that corresponds to the respective payment system user;
receiving a look-up request, the look-up request containing an alias identifier for a payment recipient; and
responding to the look-up request by returning a service provider identifier, said service provider identifier stored in said directory database in association with the recipient alias identifier.

17. The method of claim 16, wherein the alias identifier is the payment recipient's e-mail address.

18. The method of claim 16, wherein the alias identifier is the payment recipient's mobile telephone number.

19. The method of claim 16, wherein the request is received from a payment network.

20. The method of claim 19, wherein the service provider identifier is returned to the payment network.
